(19) United States
(12) Patent Application Publication
(10) Pub. No.: US 2005/0144907 A1
(43) Pub. Date: Jul. 7, 2005

(54) Material

(76) Inventor: James Martin Heaney, Londonderry (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/066,017

(22) Filed: Feb. 25, 2005

Related U.S. Application Data
(63) Continuation-in-part of application No. PCT/GB03/03769, filed on Aug. 28, 2003.

(30) Foreign Application Priority Data
Aug. 31, 2002 (GB) 0220300.8

(51) Int. Cl. B67B 1/10

(52) U.S. Cl. 53/322

(57) ABSTRACT

A material for use in the insulation and/or heating of contents placed therewith or therein, in particular a material that contains grain enclosed within an outer covering and which can be used in the storage, heating, and transportation of food.

### CROSS-REFERENCE TO RELATED APPLICATION

This application is a continuation-in-part of international application PCT/GB2003/03769, which designates the United States, filed 28 Aug. 2003, and which is incorporated herein in its entirety by reference.

### FIELD OF THE INVENTION

The present invention provides a material for use in the insulation and/or heating of contents, which are placed therewith or therein. More specifically, there is provided a material which contains grain enclosed within an outer covering which can be used in the storage, heating, and transportation of food and, in particular, take away food.

### BACKGROUND OF THE INVENTION

Currently, heated food is transported in various types of containers, such as cardboard boxes, tinfoil receptacles with cardboard lids, stainless steel containers or plastic containers, both in the fast-food service industry and food catering industry. These particular containers have a limited ability to insulate the heated food and maintain the food's temperature above 63° C. (145° F.), the temperature at which most bacteria have significantly reduced replication rates.

Other insulating devices used in the food industry include cardboard boxes, such as those used to hold take away pizza, or other food types which are not going to be consumed at the premises where they were cooked, and which are to be consumed immediately, and preferably without further re-heating.

Such boxes and containers can be inserted into a bag designed to provide further insulation to the pizza or foodstuff, in order to maintain the heat of the food.

One prior art bag is made of an outer plastic coat, which surrounds an internal insulating foam. Such insulating products have the disadvantage that they cannot maintain temperatures above 63° C. (145° F.) for any significant amount of time. Furthermore, this type of insulation is expensive to produce and is not suitable for other types of food, for example large scale catering meals.

The present invention provides an environmentally friendly and cost effective material for use in the heating and/or insulation of food. Maintaining the temperature of the food not only makes the food more appealing to the consumer, but also prevents potentially toxic bacteria from replicating in the food and thus avoids food poisoning by bacteria like Salmonella, E. Coli and Campylobacter.

### BRIEF SUMMARY OF THE INVENTION

According to one aspect of the present invention, there is provided a material for providing heat comprising a grain material in an outer covering.

The material may be formed into a bag or any other appropriate form to facilitate the heating and/or insulation of food or a container holding food. The word food as used herein includes potable drinks.

Preferably where the material is formed into a bag, the bag can be of any suitable size, shape or configuration.

In one arrangement, the bag is adapted to form a sealed envelope around the food or container which holds food, such as pre-cooked hot food, to form an insulating bag, such that the material is an insulating material.

Preferably the insulating bag at least substantially prevents heat dissipation from heated, generally cooked food, such that the food is maintained at a temperature high enough to prevent bacterial growth and replication.

In another arrangement, the bag is adapted to form a sealed pouch or the like for location next to or in the vicinity of food, for example within the food container such as a bag, carton, wrapper and the like. The food is generally heated food, such as precooked food. Hence, the bag provides heat to the food within the container, generally for at least a portion of the time between its cooking and eating, for example during transit of the food from its cooking location to its eating location.

Some foods, especially “fast foods”, can be either partly of fully cooked prior to being purchased and/or obtained by consumers. After obtaining and/or purchasing the food, consumers may expectedly or unexpectedly have a delay before eating the food, such as wanting to take the food to another location. The present invention provides heat for food that is desired to be kept heated between its cooking and its eating because of either expected or unexpected delay therebetween.

The pouch bag may have any suitable shape, possibly to fit with the shape of the food container. The shape could be flexible, and/or flat to fit a flat base of a food container.

The two forms of bag described above are useable exclusively, or in combination with each other.

Where the sealed pouch is intended to be located in a location where touching of the food is possible, it is preferable that the pouch is disposable.

The bag may be reusable or disposable, preferably the former. The bag is also preferably quilted, to maintain even coverage of the grain material.

Preferably the grain is wheat. Alternatively the grain is a mixture of wheat and another grain type or types.

Preferably the outer covering material is paper, cotton, or other cloth, Teflon® or any material suitable for insulation and/or heat transfer.

Preferably the material is heated prior to insertion of food or a food container therein, or its location therewith. Preferably the material is heated in a microwave oven.

Preferably the temperature at which the pre-cooked hot food is held at when inside or next to the heatable material is higher than 63° C. (145° F.) for as long as possible.

The invention may include one or more other substances or elements either integral with or in the vicinity of the material, possibly integral with or near to the outer covering, such as an odorous agent. Such an agent may be an aromatic or other fragrant substance, such as a coffee bean, which provides a pleasant odour to or around the food, especially when heated. More preferably the odour is wholly or substantially created by heating of the relevant agent, i.e. when heated with and/or by the heatable material described above. More preferably, the odorous agent is wholly or substantially compatible with the grain material.

A second aspect of the present invention provides a process for insulating heated food including the steps of:
a) heating a material comprising a grain material in an outer covering in a microwave oven for at least 30 seconds;
b) placing food in the heated material and forming a seal around the food. Preferably the material is as hereinbefore described.

Preferably the food is located in a container prior to location within the material.

The material can be further provided with a temperature reading device, such that the user can readily obtain a temperature reading for the inside of the insulating material.

The present invention is useable not only to keep existing food warm/hot, but also to cook or defrost food. The grain can be heated to a certain temperature, for example by an oven or similar, and then used in its own right to transfer the heat in the grain to food enveloped by the material. This provides controlled heat release, without the associated risks of unattended ovens, or over-cooking.

The present invention is also extended to other uses involving slow heat release, such as storage heating, in which pre-heating of the grain is released in a location over a following period.

The present invention is further extended to any use of the material where heat dissipation, retention or heat insulation is required.

### BRIEF DESCRIPTION OF THE DRAWINGS

An embodiment of the present invention will be now be described, by way of example only, with reference to the following drawings, wherein:

FIG. 1 is a plan view of a first insulating bag suitable for insulating hot food;

FIG. 2 is a cross section along AA of FIG. 1;

FIG. 3 is a cross-section of FIG. 1 with a hot box therein; and

FIG. 4 is a perspective view of a second insulating bag.

### DESCRIPTION OF THE ILLUSTRATED EMBODIMENT

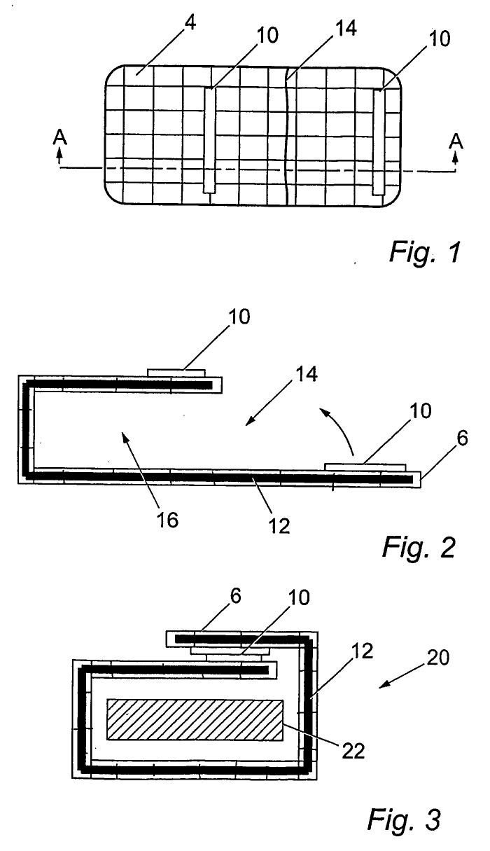

Referring to the drawings, FIG. 1 shows a pizza box insulating bag 2, having a main body 4 and flap 6. The outer covering material 8 in this case is Teflon®. A fastening means 10, for example, one strip of a hook and loop fastening material such as Velcro®, is provided on the upper surface of the main body 4 of the insulating bag. A corresponding strip of Velcro® is provided along the top rim of the flap 6. When in the closed position, shown in FIG. 3, the strips 10 co-operate to form an insulating seal. An opening 14 in the bag 2 is of suitable width to allow a pizza box or other suitable food container to be inserted and removed from the insulating bag 2. The bag 2 has seams 15 to form quilted pockets.

FIG. 2 is a cross-section of the insulating bag 2. The packed wheat grains 12 are surrounded by an outer layer, in this case Teflon® 8. Teflon® 8 provides further insulating properties as well as toughness and flexibility. The bag 2 is formed such that it has an inside pocket 16 or compartment into which a food container can be inserted.

FIG. 3 shows the bag 2 in use, insulating a container holding food 22. The bag 2 is in the closed position, with the flap 6 forming a tight seal 20 around the container 22. Prior to having the food container 22 placed inside it, the bag 2 has been heated. This heating heats the grains 12. The grains 12 retain and slowly re-emit this heat. This initial heating of the grains 12 not only results in improved insulation of the food container 22 due to a reduction in the dissipation of heat, but the grains also provide heat which additionally serves to maintain the temperature of the food.

In use, the insulating bag 2 is placed into a microwave oven and heated for at least 30 seconds at full power. Wheat has been found to be the best grain to be used for this purpose, possibly due to the high oil:water content of the seed. Three hundred grams (300 g) of wheat in a bag can be heated in a microwave oven (at 600 W power) for 90 seconds. Once filled with 200 g of hot food cooked to 90° C. (194° F.), the hot bag will keep the food temperature above 63° C. (145° F.) for at least 30 minutes. Alternatively, 1.2 kg of wheat in the bag can hold 500 g of hot food at a temperature above 63° C. (145° F.) for over 60 minutes.

Further, the heat produced during heating is maintained for longer period of time because of the higher water to carbohydrate content in the wheat seed itself. After heating the insulating bag 2, the flap 6 is opened and food containing box 22 containing a hot food is placed inside the pocket 16 of the insulating bag 2. The flap 6 is then closed over the pocket entrance so that the Velcro® strips 10 come into contact with one another and form a seal.

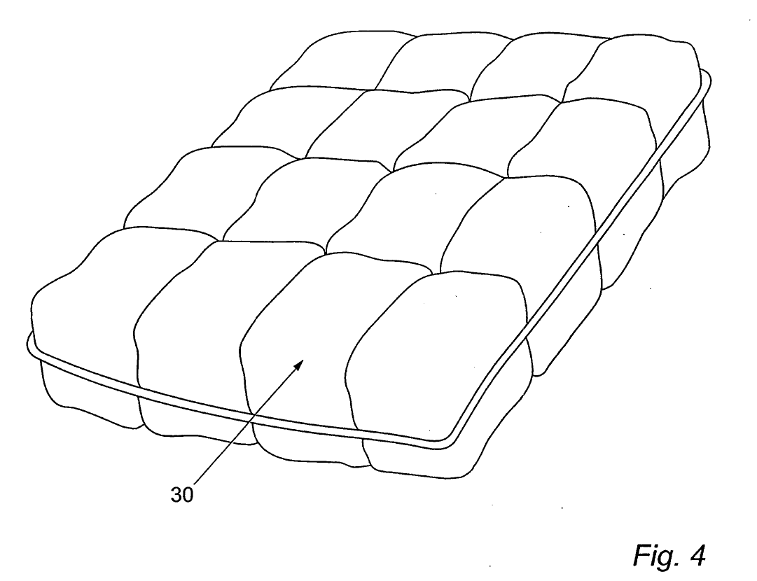

FIG. 4 shows a second bag 30 having a quilted design.

The current invention provides a cheap low cost environmentally friendly and reliable insulating bag for use in the food catering industries that can maintain food above the critical 63° C. (145° F.) temperature for up to one hour or more.

1. A material for providing heat comprising a grain material in an outer covering.

2. A material as claimed in claim 1 in the form of a bag.

3. A material as claimed in claim 2 wherein the bag is closeable.

4. A heatable device as claimed in claim 2 wherein the bag forms an envelope.

5. A material as claimed in claim 1 for containing food.

6. A material as claimed in claim 5 wherein the food is pre-cooked food.

7. A material as claimed in claim 5 for cooking food.

8. A material as claimed in claim 5 for defrosting food.

9. A material as claimed in claim 1 wherein the material is reuseable.

10. A material as claimed in claim 2 wherein the bag forms a pouch.

11. A material as claimed in claim 10 wherein the pouch is locatable next to food.

12. A material as claimed in claim 11 wherein the food is precooked.

13. A material as claimed in claim 1 wherein the outer covering is quilted

14. A material as claimed in claim 1 for use as a storage heater.

15. A material as claimed in claim 1 wherein the grain material is substantially wheat.

16. A material as claimed in claim 1 wherein the grain material is a mixture of wheat and at least one other grain.

17. A material as claimed in claim 1 wherein the material includes an odorous agent.

18. A material as claimed in claim 1 wherein the material is heatable in a microwave oven.

19. A material as claimed in claim 7 wherein the material is provided with a temperature reading device.

20. A process for insulating heated food including the steps of:
a) heating a material comprising a grain material in an outer covering in a microwave oven for at least 30 seconds;
b) placing food in the heated material and forming a seal around the food.
